(19) United States
(12) Patent Application Publication
(10) Pub. No.: US 2011/0292781 A1
(43) Pub. Date: Dec. 1, 2011

(54) METHOD FOR DETECTING OBLIQUITY OF OPTICAL DISC DRIVE

(75) Inventors: Chih-Bo LIN, Taoyuan County (TW); Song-Ruei Chen, Taoyuan County (TW)

(73) Assignee: QUANTA STORAGE INC., Taoyuan County (TW)

(21) Appl. No.: 13/092,802

(22) Filed: Apr. 22, 2011

(30) Foreign Application Priority Data
May 25, 2010 (TW) 099116917

(51) Int. Cl. G11B 27/36; G11B 20/18

(52) U.S. Cl. 369/53.35; 369/53.11; G9B/20.046; G9B/27.052

(57) ABSTRACT

A method for detecting the obliquity of an optical disc drive is provided. The method includes the steps of calibrating balance gains of TE signals and CE signals with predetermined obliquities of the optical disc drive, curve-fitting and storing a relating function between the predetermined obliquities and the balance gains, calibrating the balance gains of signals for an installed optical disc drive, and acquiring an calibrated balance gain to find the obliquity of the optical disc drive from the relating function.

This application claims the benefit of Taiwan application Serial No. 99116917, filed May 25, 2010, the subject matter of which is incorporated herein by reference.

### BACKGROUND OF THE INVENTION

1. Field of the Invention

The invention relates in general to an optical disc drive for reading/writing an optical disc, and more particularly to a method for detecting the obliquity of an optical disc drive for the optical disc drive to adjust the servo parameter in response to the obliquity.

2. Description of the Related Art

To meet with various application and space requirements of electronic products, the optical disc drive may be installed in a slanting direction. Consequently, the gravity occurred by the lens of the optical disc drive changes its direction, the servo performance of the optical disc drive is changed, and the accuracy in reading/writing high-density and tiny marks at high speed by the optical disc drive is affected.

Referring to FIG. 1, a pick-up head of an optical disc drive according to the related art is shown. The elastic metal wires 12 of the pick-up head 10 are extended from the two sides of the base 11 and connected to the two sides of the lens set 13 to support the lens set 13 by suspension. The lens set 13 has magnets and is surrounded by electromagnetic coils 14. The microprocessor 15 controls the magnitude and direction of the magnetic force of the electromagnetic coils 14 with the servo unit 16. The magnetic force resists the supporting elasticity of the metal wires 12, drives the lens set 13 to move, aligns and projects the laser beam emitted by the pick-up head 10 onto the optical disc (not illustrated), receives the reflective light beam of the optical disc, and performs focusing servo and tracking servo and generates data signals.

Normally, the optical disc drive is placed horizontally when adjusting the control parameters. When the optical disc drive tilts to the two sides, the gravity T of the lens set 13 resists the movement of the lens set 13, and the magnetic force of the electromagnetic coils 14 is thus deducted by the gravity T. Meanwhile, since the gravity T of the lens set 13 resists the elasticity of the metal wires 12, the lens set 13 is deviated to an offset position 13a or 13b from its original optical balance position which is in a horizontal direction. Consequently, the original calibrated parameter of the optical disc drive must be re-calibrated according to the obliquity of the optical disc drive. In order to detect the obliquity of an optical disc drive, the optical disc drive of related art detects whether the optical disc drive is disposed in a horizontal or a vertical direction with a mechanical detector. However, the mechanical detector not only occupies a larger space but also increases production cost.

According to U.S. Pat. No. 7,532,552, whether the optical disc drive is disposed in a horizontal or a vertical direction is determined by providing a predetermined control force for measuring the time which the lens set spends to travel a predetermined distance. However, the detection process is not simplified enough, and is unable to further determine the obliquity of the optical disc drive or correctly adjust the control parameters in response to various effects of gravity caused by the obliquity. Thus, the optical disc drive of related art still has many problems to resolve in detecting the inclination of the optical disc drive.

### SUMMARY OF THE INVENTION

The invention is directed to a method for detecting the obliquity of an optical disc drive. The balance gains of the main beam signals or the side beam signals of the optical disc drive are used for determining the obliquity of the optical disc drive.

According to an object of the disclosure, a method for detecting the obliquity of an optical disc drive is provided. The relationship between the measured obliquities of an optical disc drive and the balance gains is used for curve-fitting a relating function between the obliquities and the balance gains so as to promptly detect the obliquity of the optical disc drive.

According to another object of the disclosure, a method for detecting the obliquity of an optical disc drive is provided. The obliquity of an optical disc drive is detected according to the balance gains by which the optical disc drive generates the main beam signals or the side beam signals of the TE signals and the CE signals, hence simplifying the detection process.

To achieve the above objects of the disclosure, a method for detecting the obliquity of an optical disc drive is provided. The balance gains of the main beam push-pull signals or the side beam push-pull signals of the TE signals and the CE signals are calibrated with predetermined obliquities of the optical disc drive. The obliquities of an optical disc drive and corresponding balance gains are used for curve-fitting a relating function between the obliquities and the balance gains, and a relating function is stored. The balance gains are calibrated for an installed optical disc drive. A calibrated balance gain is acquired. The obliquity of the optical disc drive is found from the relating function according to the calibrated balance gain.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a pick-up head of an optical disc drive according to the related art.

FIG. 2 shows a pick-up head optical system.

FIG. 3 shows the generation of TE signals and CE signals.

FIG. 4 shows an optical disc drive generating inclination.

FIG. 5 shows the movement of a pick-up head optical system of an optical disc drive.

FIG. 6 is a diagram showing the relationship between the obliquities of an optical disc drive and the balance gains.

FIG. 7 shows a flowchart for curve-fitting a relating function between the obliquities of an optical disc drive and the balance gains.

FIG. 8 shows a flowchart of a method for detecting the obliquity of an optical disc drive.

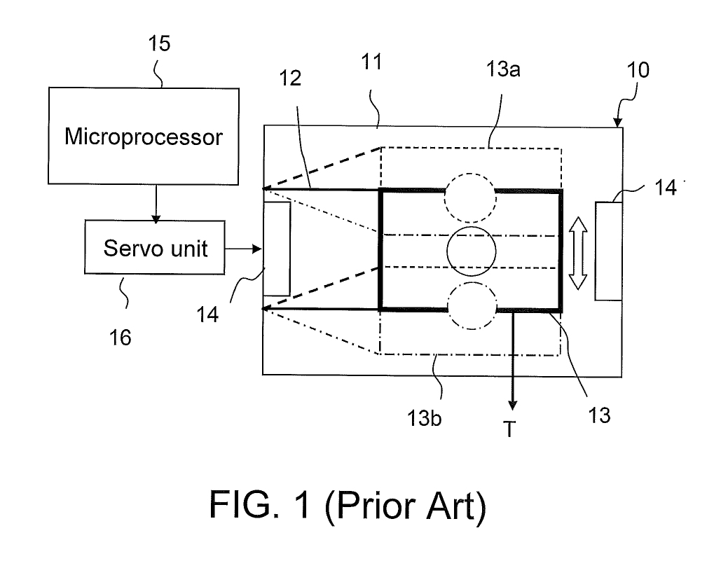

### DETAILED DESCRIPTION OF THE INVENTION

The technologies adapted in the disclosure for achieving the above objects and the effects thereof are disclosed in a number of embodiments below with accompanying drawings.

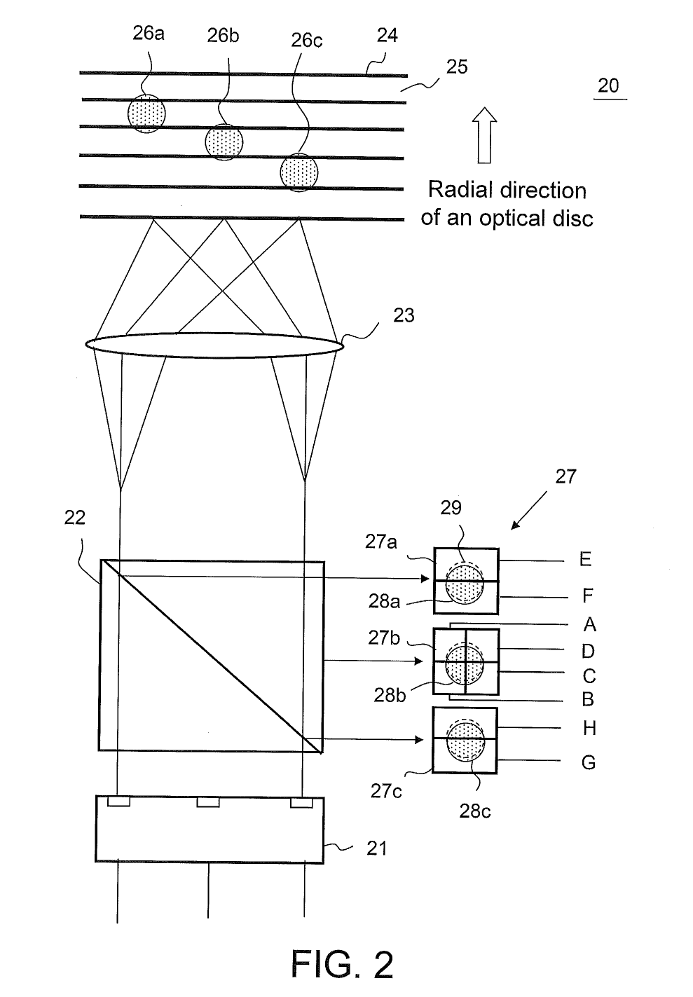

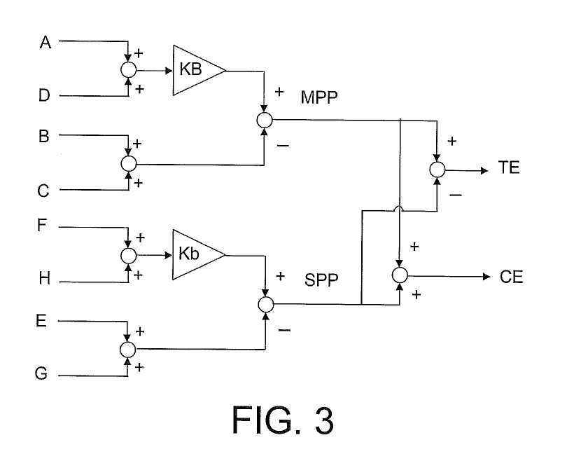

Referring to FIG. 2 and FIG. 3. FIG. 2 shows a pick-up head optical system. FIG. 3 shows the generation of TE signals and CE signals of the pick-up head. Let the pick-up head 20 of FIG. 2 be taken for example. The pick-up head 20 is a tri-beam optical system, which focuses three beams generated by the laser diode 21 on the data tracks 25 of the optical disc 24 via the lens 23 to form three light spots 26a, 26b and 26c, wherein the three beams pass through the optical element 22. The optical disc 24 further reflects the three light spots 26a, 26b and 26c to the pick-up head 20, and then the three light spots are all reflected to the transducer 27 via the optical element 22. The transducer 27 includes three sub-transducers 27a, 27b and 27c, which respectively receive the light spots 28a, 28b and 28c reflected from the three light spots 26a, 26b and 26c. The first sub-transducer 27a is composed of reception portions E and F. The second sub-transducer 27b is composed of reception portions A, B, C and D. The third sub-transducer 27c is composed of reception portions G and H. The transducer 27 receives the reflective light to form signals such as tracking error (TE) signals and central error (CE) signals.

The optical disc drive generates signals by way of differential push-pull (DPP) method. According to the DPP method, the reflective lights received by the reception portions A, B, C, D, E, F, G and H are converted into main beam push-pull (MPP) signals and side beam push-pull (SPP) signals as indicated in FIG. 3. The MPP signals are obtained by deducting the sum of the signals formed by the reception portions B and C from the sum of the signals formed by the reception portions A and D. However, due to the optical difference and circuit structural difference between individual optical disc drives, the reflective light spot 28b is offset and cannot be precisely aligned with the ideal balance point 29 (denoted in dotted lines). Consequently, the area of the part of the reception portions A and D that receives the reflective light spot 28b and the area of the part of the reception portions B and C that receives the reflective light spot 28b are not the same, so that the signals are offset. Therefore, the signal balance is calibrated according to the balance gains KB so as to form a new balance point at the position to which the reflective light spot 28b is offset, and the main beam push-pull signal is expressed as:

MPP=(A+D)×KB−(B+C)

The SPP signals are obtained by deducting the sum of the signals formed by the reception portions E and G from the sum of the signals formed by the reception portions F and H. However, due to the optical difference and circuit structural difference between individual optical disc drives, the reflective light spot 28a and 28c are offset and cannot be precisely aligned with the ideal balance point 29 (denoted in dotted lines) and consequently the signals are offset. Therefore, the signal balance is calibrated according to the balance gains Kb so as to form a new balance point at the position to which the reflective light spot 28a and 28c are offset, and the side beam push-pull signal is expressed as:

SPP=(H+F)×Kb−(G+E)

Then, the MPP signals are deducted by the SPP signal to form TE signals which control the pick-up head 20 to track the data track 25. Then, the MPP signals are added by the SPP signals to form CE signals which control the lens 23 to deviate from the center of the pick-up head 20.

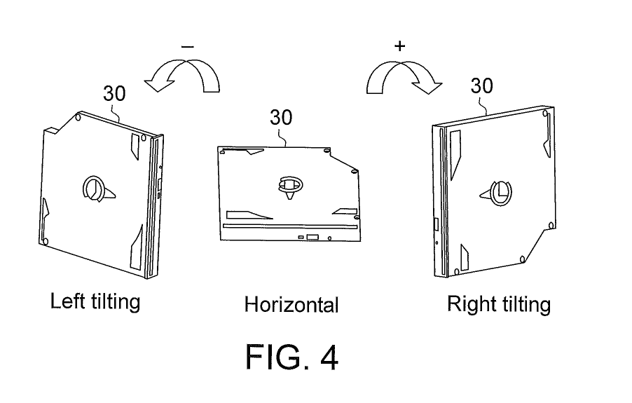

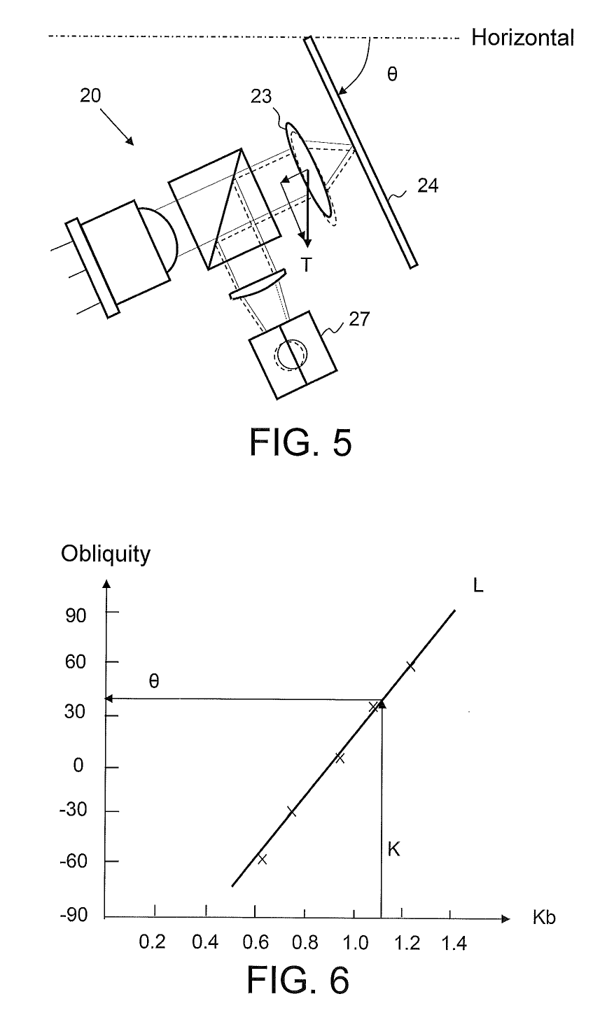

Referring to FIG. 4 and FIG. 5. FIG. 4 shows an optical disc drive generating inclination. FIG. 5 shows the movement of a pick-up head optical system of an optical disc drive. In general, the optical disc drive 30 is horizontally disposed, that is, the optical disc 24 is disposed in a horizontal direction, and the pick-up head 20 projects a light beam onto the optical disc 24 from underneath to read/write data. When the optical disc drive 30 is disposed in a horizontal position, the gravity T of the lens 23 is perpendicular to the optical disc 24 for moving the lens 23 vertically without deviating from the balance point. However, when the optical disc drive 30 tilts to the left or to the right at an obliquity 8, the gravity T of the lens 23 generates a component of force, which is parallel to the optical disc 24 and resists the elastic metal wires that support the lens 23 by suspension, causing the lens 23 to be offset as indicated in the dotted lines of FIG. 5. Consequently, the reflective light spot received by the transducer 27 is deviated from the balance point, and the balance gains KB and the balance gains Kb can no longer be adapted to the MPP signals and the SPP signals respectively and need to be calibrated.

The component of force generated by the gravity T of the lens 23 is parallel to the optical disc 24 and varies with the obliquity 8, and the larger the obliquity θ grows, the larger the component of force becomes. As the obliquity θ grows larger, the component of force of the gravity T of the lens 23 in a direction parallel to the optical disc 24 also becomes larger, making the elastic metal wires of the lens 23 being offset wider, wherein there is a relationship existing. Meanwhile, the balance gains KB of the MPP signals and the balance gains Kb of the SPP signals also vary with the magnitude of the displacement, and there is a relationship existing between the balance gains KB and Kb of the signals and the obliquities θ. The disclosure find the obliquity of an optical disc drive from the relationship between the obliquities θ and the balance gains KB and Kb with the balance gains KB and Kb which are easy to acquire.

Referring to FIG. 6, a diagram showing the relationship between the obliquities of an optical disc drive and the balance gains of signals is shown. Before the obliquity of the optical disc drive is detected, the optical disc drive is rotated to several obliquities θ such as −60, −30, 0, 30, 60 degrees, wherein the clockwise rotation is denoted as +direction and the anti-clockwise rotation is denoted as −direction, and the balance gains KB of the MPP signals or the balance gains Kb of the SPP signals calibrated at each obliquity θ are measured. Let the balance gains Kb of the SPP signals be taken for example. The obliquities and the balance gains measured accordingly are marked in a coordinate diagram for curve-fitting a relating function. For example, the relating function is curve-fit as a straight line L by way of linear approximation. Once an optical disc drive is installed, the balance gains of the MPP signals or the SPP signals can immediately be calibrated, and the obliquity θ of the optical disc drive can be found by interpolating or extrapolating the straight line L, which denotes the relating function between the obliquities and the balance gains, to adjust the control parameters of the optical disc drive corresponding to the obliquity θ.

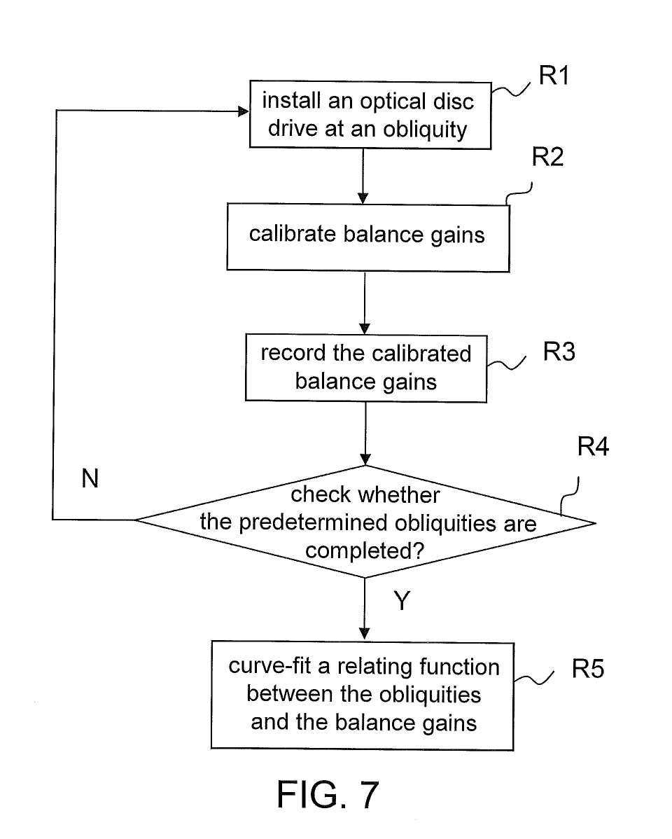

Referring to FIG. 7, a flowchart for curve-fitting a relating function between the obliquities of an optical disc drive and the balance gains is shown. The steps of acquiring the obliquity of an optical disc drive according to a calibrated balance gain are disclosed below: Firstly, at step R1, an optical disc drive is installed at a plurality of predetermined obliquities. Next, at step R2, the balance gains of the MPP signals or the SPP signals are calibrated for an inclined optical disc drive. Then, at step R3, the calibrated balance gains corresponding to the obliquities of the optical disc drive are recorded. After that, at step R4, whether the predetermined obliquities are completed is checked. If the measurement of predetermined obliquities is not yet completed, then the method returns to step R1, the optical disc drive installed at another obliquity is tested. If the measurement of predetermined obliquities is completed, then the method proceeds to step R5, the relating function between the obliquities and the balance gains is curve-fit according to the obliquities recorded in step R3 and their corresponding balance gains.

According to the method for detecting the obliquity of an optical disc drive of the disclosure, the relating function between the obliquities and the balance gains can be curve-fit according to the relationship between the measured obliquities of the optical disc drive and the balance gains of the MPP signals or the SPP signals and then the relating function is stored for the optical disc drive to use, wherein the balance gain changes as the balance point is offset due to the inclination of the optical disc drive.

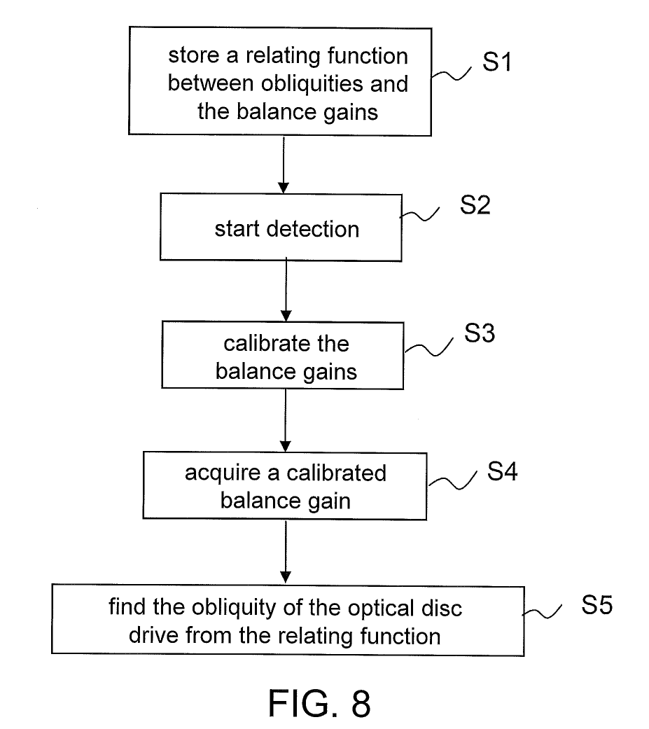

Referring to FIG. 8, a flowchart of a method for detecting the obliquity of an optical disc drive is shown. The steps of determining the obliquities of an optical disc drive according to the balance gains of an installed optical disc drive are disclosed below: Firstly, at step S1, a relating function between obliquities and the balance gains is stored. Next, at step S2, the obliquity of an optical disc drive is detected after the optical disc drive is installed. Then, at step S3, the balance gains of the MPP signals or the SPP signals are calibrated. After that, at step S4, a calibrated balance gain is acquired. Afterwards, at step S5, the obliquity of the optical disc drive corresponding to the calibrated balance gain is obtained from the relating function stored in step S1 and the calibrated balance gain acquired in step S4 for adjusting the control parameters of the optical disc drive.

Thus, the method for detecting the obliquity of an optical disc drive of the disclosure can easily and quickly find the obliquity of an optical disc drive by interpolating or extrapolating the stored relating function between the obliquities and the balance gains, wherein the relating function is curve-fit according to the predetermined obliquities and their corresponding balance gains of the main beam signals or the side beam signals of the TE signal and CE signal generated by the optical disc drive.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for detecting obliquity of an optical disc drive, comprising:
(1) storing a relating function between obliquities and balance gains;
(2) calibrating the balance gains of signals for the optical disc drive;
(3) acquiring a calibrated balance gain; and
(4) finding the obliquity of the optical disc drive from the relating function according to the calibrated balance gain.

2. The method according to claim 1, wherein the balance gains are balance gains of TE (tracking error) signals and CE (central error) signals.

3. The method according to claim 2, wherein the balance gains are balance gains of main beam push-pull signals of the TE signals and the CE signals.

4. The method according to claim 2, wherein the balance gains are balance gains of side beam push-pull signals of the TE signals and the CE signals.

5. The method according to claim 1, wherein in the step (1), before the relating function is stored, the step (1) further comprises:
calibrating the balance gains according to a plurality of predetermined obliquities of an optical disc drive, and curve-fitting a relating function between the obliquities and the balance gains with the obliquities of the optical disc drive and their corresponding balance gains.

6. The method according to claim 1, wherein in the step (2), the balance gains of main beam push-pull signals or side beam push-pull signals are calibrated.
